(19) United States
(12) Patent Application Publication
(10) Pub. No.: US 2017/0257918 A1
(43) Pub. Date: Sep. 7, 2017

(54) UNIVERSAL LED DRIVER SWITCHING CIRCUIT

(71) Applicant: BASIC6 INC., Westport, CT (US)

(72) Inventors: Victor ANSART, Greenwich, CT (US); John STEIN, Ashburn, VA (US); Magnus WENNEMYR, Amherst, MA (US)

(21) Appl. No.: 15/449,300

(22) Filed: Mar. 3, 2017

Related U.S. Application Data
(60) Provisional application No. 62/303,914, filed on Mar. 4, 2016.

(51) Int. Cl. H05B 33/08; H04B 10/50; H04B 10/116; H04B 10/516

(52) U.S. Cl. CPC H05B 33/0824; H05B 33/0845; H04B 10/516; H04B 10/502; H04B 10/116; H05B 37/0245

(57) ABSTRACT

Apparatus including a light emitting diode; a constant current source for driving the diode; modulation circuitry for modulating the current supplied to the light emitting diode so that digital information can be carried on light from the diode; and a filtering circuit between the constant current source and the light emitting diode to minimize the effect of LED modulation on the current source. Alternatively, the constant current source can supply current to the diode or to one of a power dissipating element or power storage element. A method for powering a light emitting diode includes using a constant current source; and modulating the current supplied by the constant current source at a frequency for transmitting digital data on light produced. In the alternative, a method can also include diverting current from the constant current source away from the light emitting diode, when the light emitting diode is not emitting light.

### CROSS REFERENCE TO RELATED APPLICATION

This application claims priority from and the benefit of provisional patent application Ser. No. 62/303,914 filed on Mar. 4, 2016, the entire contents of which are incorporated herein by reference.

### BACKGROUND OF THE DISCLOSURE

1. Field of the Disclosure

The present disclosure relates to the Internet of Things (IoT); essentially the set of connectable and identifiable electronic devices that are being installed in our surroundings. More particularly, this disclosure relates to the technology of light-emitting diodes (LED), and drivers for LEDs.

2. Description of the Related Art

With the IoT “smart” devices have proliferated. These devices are capable of a greater range of functionality and communication. Focus in this burgeoning field is at this time largely on the “Application” side (your door at home opens, you receive a text so stating). The way such devices operate is typically with a microcontroller (MCU)-based program that collects data about and controls its environment via sensors and actuators. Smart devices include WiFi or other communication modes, and sometimes even include an external microprocessor (MPU) running a full-fledged operating system that greatly extend the device's capabilities. In such cases, the application running on the MCU may call libraries on the MPU to process information to inform device control decisions, and the application may send data back targeting a customer's data store.

Semi-conductor based lighting, and in particular LED lighting, has many advantages over incandescent light sources including lower energy consumption, longer lifetime, improved physical robustness, smaller size, and faster switching.

It is the capability of LEDs that enables light to be used as a medium over which data can be communicated from an LED to a light-sensitive receiver. In its simplest form, this visible light communications (VLC) works by switching the LEDs off and on at a very high rate in patterns that communicate information. With an additional light sensitive receiver and accompanying circuitry, the LED can become a node capable of bidirectional communication. For this to be meaningful, an appropriate light sensitive receiver and transmitter at a far end, is required. In its simplest form, an LED may be used to emit a repeated uniquely identifying pattern, an “ID”, which can be used by a receiving device to pinpoint its location when it is in the path of the light emitted by the LED (“GeoLiFi”). For convenience, the terms LiFi and VLC will be used to describe communication of data by blinking an LED in any fashion, irrespective of whether there is a bidirectional capability.

LEDs are powered by supplies termed drivers, typically implemented in such a fashion as to yield a constant current. The purpose for doing so is two-fold: firstly to avoid exceeding the maximum current rating of the LED and secondly to obtain predictable light intensity and color. Driver circuitry is designed to protect the LED from damage, and can itself vary in sophistication. In most cases, constant current drivers may actively monitor and detect sudden loss of power, and react by shutting down, or by trying to correct the signal. In so doing, a driver may alter any desired properties of a signal that is designed to intentionally modulate the output of the LED by switching it on and off.

It is possible that the process that modulates a signal through the LED in and of itself expose the driver to changes in power output, which then can react by temporarily shutting itself down, leading to undesirable flicker of the LED, and an alteration or deterioration of the emitted signal as perceived by a receiver. Even small oscillatory changes to the output due to the modulating circuitry can cause parts of the driver to charge and discharge continuously, which can cause an undesirable audible ringing of the driver, accompanied by a reduced driver lifetime. For these reasons, maintaining a smooth output voltage and current for the driver is critical to maintaining driver stability and preventing premature driver failure.

Provisional Patent Application Ser. No. 62/274,619, filed on Jan. 4, 2016, entitled Adapter Extending Capabilities of Remote Control and LiFi To Installations of Light-Emitting Diode-Based Luminaires and corresponding application Ser. No. 15/398,464 filed on Jan. 4, 2017, describes a possible environment for use of the embodiments disclosed herein, where LiFi and remote control are added to the luminaire containing the LED and driver. The circuits disclosed herein also can be added.

### SUMMARY OF THE DISCLOSURE

Circuitry added to existing driver-LED systems in order to modulate the signal to and subsequently emitted by an LED was developed to abide by the requirements of the existing drivers to produce constant current, while allowing full control of the modulated signal.

In general, the disclosure addresses technology that can be encased fully or partly within the luminaire during the manufacturing stages, but specifically where circuitry is external to constant-current driver circuits, whether housed in the same casing as the driver or not. The control module circuits so added, whereby the capabilities of an existing LED can be extended with IoT and LiFi capabilities, allow the drivers to retain their constant-current property, thus allowing their proper functioning. Further, power derived from the manner in which this is accomplished is channeled to power the circuits themselves. A fully functioning prototype is implemented exhibiting these properties in such a fashion that existing driver-LED constellations may be modified without requiring their replacement. Alternatively, the disclosed circuitry may be incorporated during the manufacturing stages of the luminaire. The term device is here used to describe the entire smart LED luminaire, including all circuitry. The device can be placed within and be part of a distributed computational environment that brings data from and control to the device from across the globe.

In general, this disclosure is directed to an apparatus comprising a light emitting diode; a constant current source for driving the light emitting diode; and modulation circuitry for modulating the current supplied to the light emitting diode at a rate sufficient so that digital information can be carried on light emitted by the light emitting diode.

The modulation circuitry can comprise a switching element for supplying power to the light emitting diode; and a filtering element; wherein the filtering element minimizes the voltage and current oscillations experienced by the driver when switching the light emitting diode. This filtering element is a key component of the first embodiment described herein. The system is designed to be universal and function with any type of constant current driver as long as the current and voltage outputs of the driver are within the ratings of the components in the circuit. (The design also works with other types of drivers such as constant voltage drivers but those are rarely used in LED control applications since LED's are better regulated by current rather than voltage.)

The modulation circuitry can further comprise a modulation signal source for supplying a modulation signal to the switching element. The modulation signal source can comprise at least one microcontroller or microprocessor. The modulation circuitry can also be isolated from the modulation signal source by using isolation circuitry such as a digital isolator or an opto-isolator.

The apparatus can be disposed in an adapter to be used to provide power from a source to a light emitting diode otherwise not driven by a constant current source. Alternatively, the apparatus can be packaged as a self-contained unit for connection to a power source. The apparatus can further comprise communications circuitry for allowing the apparatus to communicate via a network and to control the power to the driver to, for instance, switch the LED off and on, or to dim it.

In the latter case, it may be necessary or preferable to isolate the modulation circuitry by introducing a digital isolator between the control circuitry and the LED switching MOSFET to allow the control circuitry ground and the constant current driver ground to be at different voltage levels. A voltage regulator powered by the driver may be used to power the switching side of the digital isolator. Alternatively, an isolated voltage source may be employed. The control side of the digital isolator can be powered directly by the control side power rail. A digital isolator is preferred over an opto-isolator which may be too slow to properly meet the modulation signal speed requirements.

The disclosure is also directed to a method for powering a light emitting diode, comprising using a constant current source to power the light emitting diode; and modulating current supplied by the constant current source at a frequency for transmitting digital data on light produced by the light emitting diode.

An alternative circuit was also created where the solution is of a different kind, where circuitry is included the specific purpose of which is to minimize the total power consumption of a system into which the modulating circuitry was added. In this circuit, the constant current source can supply current to either the light emitting diode or a power dissipating element other than the light emitting diode. In this case, the method can comprise diverting current from the constant current source away from the light emitting diode, when the light emitting diode is modulated to not emit light. The current can be diverted to one of an energy dissipating and an energy storage device, where the energy dissipating device may be control and communication circuitry.

Here, the modulation circuitry can comprise a first switching element for supplying power to the light emitting diode; a power dissipating element; and a second switching element for supplying current to the power dissipating element; wherein only one of the first switching element and the second switching element supply power at a given time, so that the current supplied by the constant current source remains substantially constant.

The modulation circuitry can further comprise a modulation signal source for supplying a modulation signal to one of the first switching element and the second switching element; and a logic inverter for supplying an inverted form of the modulation signal to another of the first switching element and the second switching element.

The constant current source can supply current to either the light emitting diode or a power storing element. The power storing element can be a capacitor. The power stored on the capacitor can be used to power a control and modulation circuit to provide a signal for modulating light output of the light emitting diode or for additional or other purposes.

The modulation circuitry can further comprise a first switching element for supplying power to the light emitting diode; a second switching element for supplying current to the power storing element; wherein only one of the first switching element and the second switching element supply power at a given time, so that the current supplied by the constant current source remains substantially constant.

When the power storing element is a capacitor, the apparatus can further comprise a voltage regulator circuit for regulating the voltage produced across the capacitor. The voltage regulator circuit includes a boost converter if the voltage in the capacitor is below a predetermined voltage. The voltage regulator circuit includes a buck converter if the voltage in the capacitor is above a predetermined voltage. The voltage regulator circuit includes a buck-boost converter if the voltage in the capacitor is at times below and at times above a predetermined voltage.

### BRIEF DESCRIPTION OF THE DRAWINGS

FIG. 1 is a schematic diagram of a simplified circuit using a constant current source to drive an LED.

FIG. 2 is a schematic diagram of improved simplified circuitry using a constant current source and a filter circuit to drive an LED.

FIG. 3 is simplified diagram of a filter useful in the circuit of FIG. 2.

FIG. 4 is a schematic diagram of another embodiment of improved simplified circuitry using a constant current source to drive both an LED and modulation and control circuits.

FIG. 5 is a schematic diagram of a circuit that supports two LED constant-current drivers, one of which feeds two separate LEDs.

FIG. 6 is a schematic diagram of other improved simplified circuitry using a constant current source to drive both an LED and modulation and control circuits in an energy-efficient manner.

FIG. 7 is a block diagram of the environment for use of circuitry disclosed herein.

FIG. 8 is a system diagram that shows the circuits disclosed herein being managed from a device management platform.

A component or a feature that is common to more than one drawing is indicated with the same reference number in each of the drawings.

### DESCRIPTION OF THE EMBODIMENTS

This application is related to patent application Ser. No. 14/671,694 filed on Mar. 27, 2015, published as United States Patent Publication No. 2015/0281337, which claims priority from and the benefit of provisional patent application Ser. No. 61/972,754, filed on Mar. 31, 2014. This application is also related to provisional patent application Ser. No. 62/274,619, filed on Jan. 4, 2016. These applications are incorporated herein by reference, in their entirety, for all purposes.

In general, the disclosure addresses technology that can be encased fully or partly within the luminaire during the manufacturing stages. Furthermore, it also addresses the particular use case where IoT and LiFi incapable LEDs have already been installed. For that, an adapter and accompanying system has been designed and a fully functioning prototype implemented whereby the capabilities of an existing LED is extended with IoT and LiFi capabilities, without requiring the replacement of the LED. The same adapter may be installed during manufacturing. The device can be placed within and is part of a distributed computational environment that brings data from and control to the device from across the globe.

The disclosure is also directed to an adapter for connection between a luminaire and a power input for powering the luminaire, comprising circuitry for modulating light output of the luminaire to contain information, or circuitry for connection to a network so that signals associated with the luminaire are communicated on the network.

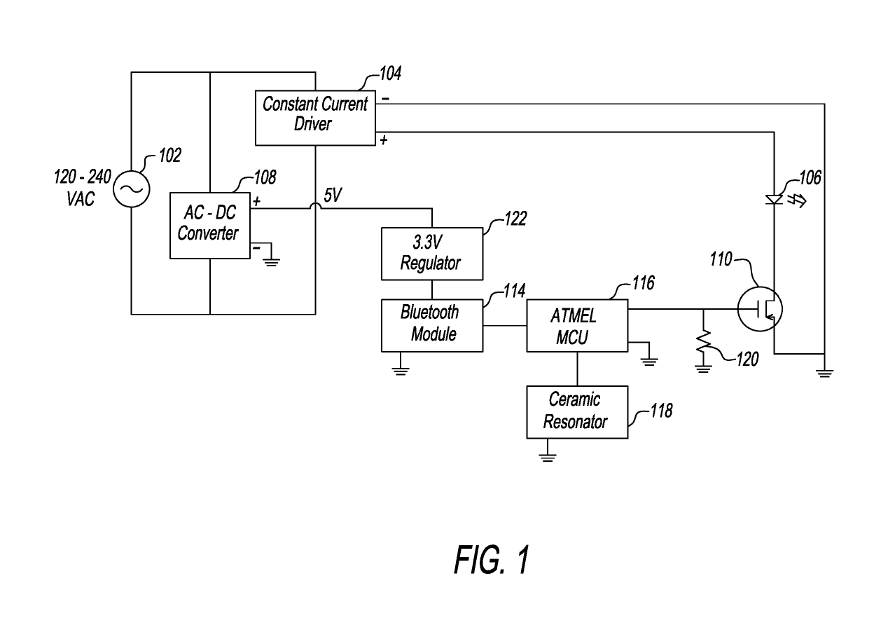

In FIG. 1, a circuit 100 is embodied in a naïve state. It is also slightly simplified for purposes of illustration. What has been added to the basic components of the luminaire is mains power 102, a constant current driver 104 and LED 106, is an AC-to-DC converter 108 appropriate for powering the components, components to manage communication and remote control of the device as well as the modulation of the LED 106, and a transistor 110, such as a MOSFET transistor, that alternatingly allows or denies current from flowing through the LED 106 depending on the state of the voltage at its gate.

Continuing in FIG. 1, an external agent networks with circuit 100 via Bluetooth, where the device includes a Bluetooth chip 114. It is equally possible to connect the luminaire using Wifi, ZigBee or Thread or cellular chips, via a direct Ethernet® connection, Ethernet over power, or other means to communicate with a network. The circuit board's Bluetooth is in this case configured to connect to a gateway that provides a communication channel, typically to the broader internet, over which control of the circuit can be exerted, but could also be connected directly to the internet via a router.

An MPU 116, such as for example, a B1010-SP0 is programmed with software to manage communication interaction and logic, and to communicate control signals to a network. MCU 116 is provided with a ceramic resonator 118, to provide a stable clock cycle, and to run software dedicated to outputting the desired modulation in a stable fashion by generating a voltage output to the gate of transistor 110. The exact type of microcontroller is not considered inherent to the current invention, and may be replaced by components that perform equivalent tasks using single or multiple other microcontroller and/or microprocessor chips that manage communication and the modulation of the signal chosen according to various performance requirements such as the frequency at which modulation should occur.

The proper voltage to operate the chips or integrated circuit packages of FIG. 1 are provided by a voltage regulated supply, generally producing a DC output of 5 volts from the AC-to-DC converter 108 and 3.3 volts from the voltage regulator 122.

Raising and lowering the voltage above and below the gate voltage threshold of the transistor 110, based on the voltage across a resistor 120, generated by MCU 116, will allow or deny a current (beyond a small leakage) through the LED 106. At this point the conflict in the complete circuit may be evident. Blinking the LED on and off by allowing and interrupting the current is inconsistent with the design of the constant-current driver 104. Depending on the circuitry within the driver 104, it may react in a variety of ways to interruptions to its current, including shutting down the power to the LED 106 altogether. Solving this issue is at the core of this disclosure.

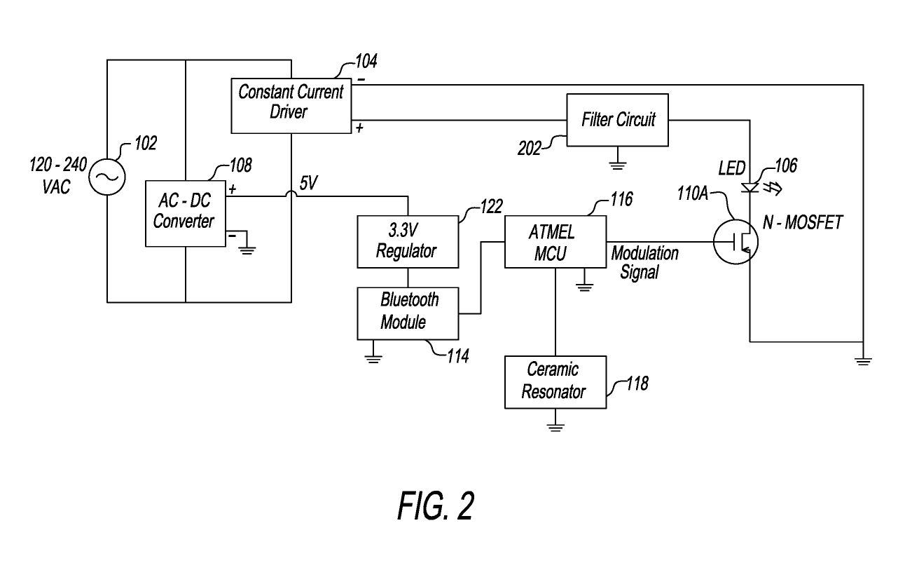

In FIG. 2, the circuit is embodied in a form where a filter circuit 202 has been added between the constant current driver 104 and the LED switching circuit (LED 106 and transistor 110A). Filter circuit 202 is preferably a low pass filter, which is used to minimize the current and voltage oscillations experienced by the constant current driver 104 when the light emitting diode 106 is being switched according to the modulation signal. A number of circuit topologies can be used for the filter circuit including, but not limited to a pi filter, a T filter, an RC filter, active filters, etc.

In this embodiment, an N-Channel MOSFET is considered preferable to other transistor types as they are easily controlled by the outputs of a microcontroller and exhibit shorter response times. However, variations are possible, for instance with bipolar junction transistors, to be applied using this same approach of allowing a constant current to flow from the driver.

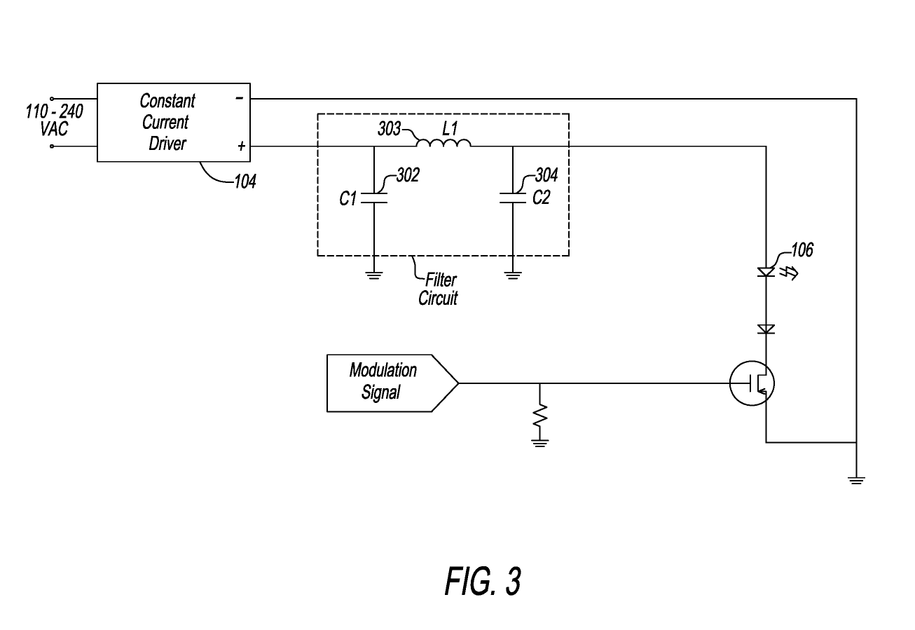

FIG. 3 provides a more detailed description of the filter circuit, depicting a pi filter as the low pass filtering topology. The operation of this circuit can be described from two different perspectives that both explain how the circuit works, firstly the perspective of the time domain and secondly the perspective of the frequency domain. Per the time domain perspective, the modulation circuit can be explained as the following: When transistor 110 is off, no current flows through LED 106 and LED 106 is in the off mode. However, current must still flow out of the constant current driver 104 for which reason capacitors 302 and 304 are charged. These capacitors charge exponentially during the time that transistor 110 is off. When transistor 110 turns on, current is allowed to flow through LED 106 and LED 106 turns on. Capacitors 302 and 304 discharge exponentially through LED 106 while driver 104 continues to deliver a constant current, which increases the total current through LED 106 as the capacitors discharge. This cycle repeats itself as transistor 110 turns on and off repeatedly. The inductor 303 in the circuit resists the change in voltage caused by the charging and discharging of the capacitors and serves to further reduce the voltage oscillations experienced by the driver 104.

Per the frequency domain explanation, the driver 104 experiences capacitor 302 as a constant non-changing capacitive load. This non-changing load allows capacitor 302 to output a constant current without seeing large voltage oscillations. The inductor 303 has a high impedance to oscillatory signals while having a low impedance to DC signals. Inductor 303 has the effect of blocking the voltage oscillations caused by the modulation of LED 106 while allowing the constant current from driver 104 to be sent to LED 106 with little impedance. In effect, capacitor 304 serves to power LED 106 when it is being modulated by transistor 110 and minimizes the voltage fluctuations caused by the modulation. Overall, capacitor 302, inductor 303, and capacitor 304 work together to minimize the voltage oscillations experienced by the driver when modulating the LED 106.

In order to achieve the requisite level of attenuation, the values for capacitors 302 and 304 and for inductor 303 are chosen so that the corner frequency for the pi filter are removed far from the modulation frequency of LED 106. The formula to determine the corner frequency of the pi filter is F=1/(2*π*(L*C)̂(½)).

The circuit described above in FIGS. 2 and 3 is considered to be a preferred embodiment as it stores the energy when the LED is off and releases it back to the LED when the LED is turn back on.

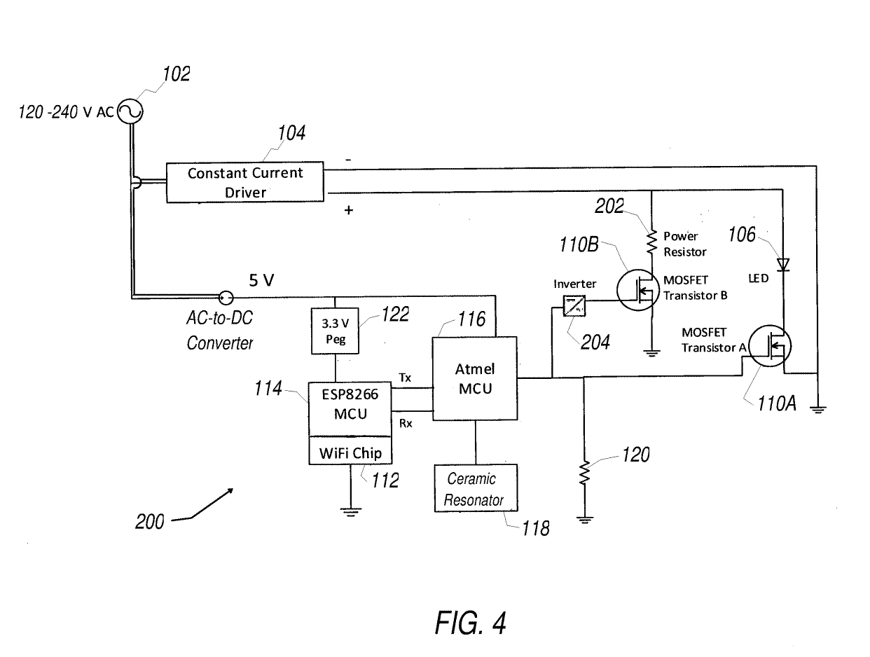

In FIG. 4, in a different embodiment, the circuit includes a sub-circuit added to allow constant current to flow from the constant current driver 104. The basic idea is to at any one time channel current generated by the constant-current driver through either a power resistor 202 or the LED 106 without interruption. This is accomplished by controlling from the same MCU-regulated output voltage the current through these components with the combination of two MOSFET transistors 110A and 110B. However, the input voltage to transistor 110B is controlled by an inverter 204. Inverter 204 acts to switch the voltage at the gate of MOSFET transistor 110B high when the output of MCU 116 is low, and low when the output of the MCU 116 is high. Accordingly, the gate voltages at transistors 110A and 110B will always be opposite high and low at any one time, allowing current to flow through either one of the two legs attached to driver 104. Current flowing through power resistor 202 is dissipated in the form of heat.

It is possible to create a circuit without transistor 110B where current is forced to flow through the power resistor 202 in a passive fashion. At least two different problems emerge from this simpler design. A large enough power resistor is required to prevent any significant leakage through the resistor during the LED “on” stage. Accordingly, during the LED “on” stage, a very large valued resistor is desired. During the LED “off” stage, all of the current will flow through the resistor. Since the driver is a constant current source, a voltage is created across the resistor that is directly proportional to the value of the resistor in accordance with Ohm's law (V=IR). If the value of this resistor is high enough, the voltage across the resistor will exceed the voltage operating range of the generating driver, with consequences that are difficult to predict. This creates a challenge: to find a resistor value that allows safe operation of the driver in terms of its voltage range while minimizing current leakage through the resistor during the LED “on” stage. Secondly, when a large resistor is chosen to minimize current flowing through the resistor during the LED “on” stage, a significant amount of power will dissipate through the resistor (the power through the power resistor is directly proportional to the size of the resistor (P=I²R), and the heat thus generated can become unacceptable. By using a second transistor 110B to control the current flow, the size of the resistor can be chosen to be significantly smaller, and commensurately less heat dissipated.

The circuit in FIG. 4, and any such circuit diverting current to a dissipative resistor, must to be able to dissipate significant amount of heat in order to maintain stability. This is because the circuit will need to dissipate the power caused by the current flowing through the dissipative resistor when the LED is turned off. If the constant current driver outputs a large amount of current, this power can become difficult to dissipate effectively. Therefore, as noted above the circuit in FIGS. 2 and 3 is considered preferable as it does not need to dissipate this power. However, there are cases where it may be economical to use circuits having a dissipative resistor.

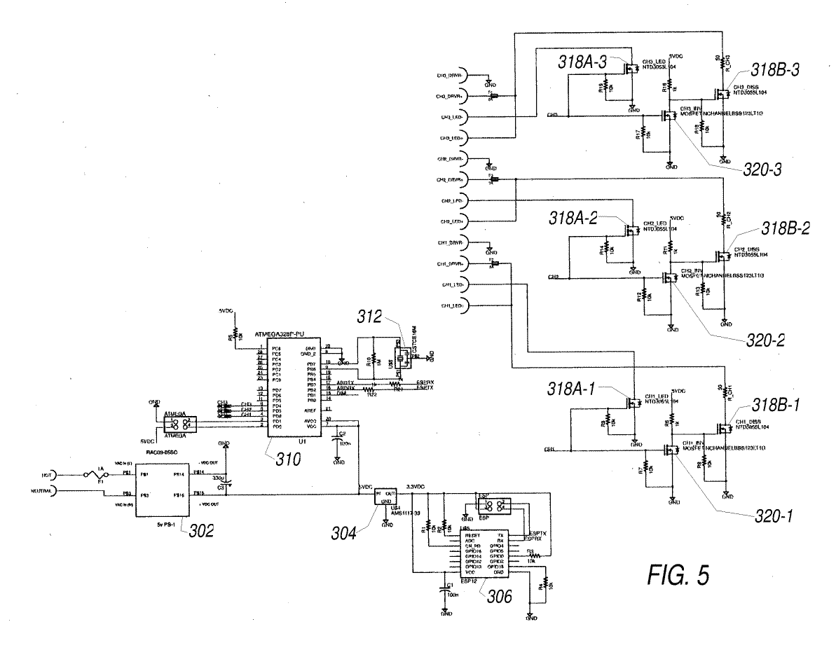

In FIG. 5, the circuit is embodied in a fully functional form from which a circuit board may be created. It is complicated slightly by the fact that it supports two LED constant-current drivers, one of which feeds two separate LEDs. The LEDs and drivers are not depicted as this represents the design of a board that is added to a pre-manufactured luminaire. Some additional minor componentry (resistors, capacitors) also depicted is necessary for the proper functioning of the microcontrollers and the power transformer, as described below.

An AC to DC converter 302, such the RAC03-05SC power line converter, converts to 5 volts DC. Converter 302 supplies the 5 volts to a low dropout voltage regulator 304 for converting the input of 5 volts to an output of 3.3 volts. The voltage regulator feeds an ESP12 development board 306 (one of several ESP8266 development boards), which is a microcontroller and Bluetooth chip 306 with a full TCP/IP stack. The 5 volts output also feeds the microcontroller chip 310 and areas of the circuitry in the upper right of FIG. 5.

The Bluetooth portion of chip 306 receives instructions over its Bluetooth capability, manipulates the incoming commands with the microcontroller software in chip 310, and signals controls via lines labeled ESPTX and ESPRX to an ATMEGA chip along the corresponding receiving ends labeled ARDTX and ARDRX.

The chip 310 can be an ATMEGA328P-PU 8-bit microcontroller, the role of which is to emit a precise modulation of the signal by switching the voltages on and off at pins PD2, PD3 and PD4. To this end, a ceramic SMD crystal 312, such as a CSTCE16M, is connected to chip 310. Crystal 312 resonates at a stable frequency, lending precision to the clocking.

The Voltages at pins PD2, PD3 and PD4 of chip 310 correspond to labeled lines CH1, CH2 and CH3. These are three separate outputs of chip 310, each of which control a driver's current output. These same labels recur in the circuits of the upper right where three separate channels for pairs of LEDs and drivers (components not shown) form 12 connection points.

The circuitry for each of the three channels is identical. For Channel 1, the source-drain current of the two MOSFETS transistors 318A-1 and 318B-1, such as NTD3055L104 transistors, (CH1 LED and CH1 DISS) are controlled by the voltage applied from CH1, where CH1 is connected directly to the gate of the CH1 LED transistor, but connected to the CH1 DISS transistor via a third MOSFET 320-1 (for example a BSS123LT1G transistor), which acts as a voltage inverter. This use of inverter and two current-channeling transistors directly corresponds to the two transistors and inverter of FIG. 4, where their functionality is described in detail. The same components are used for Channel 2 and Channel 3, with the components having -2 and -3 suffixes, respectively.

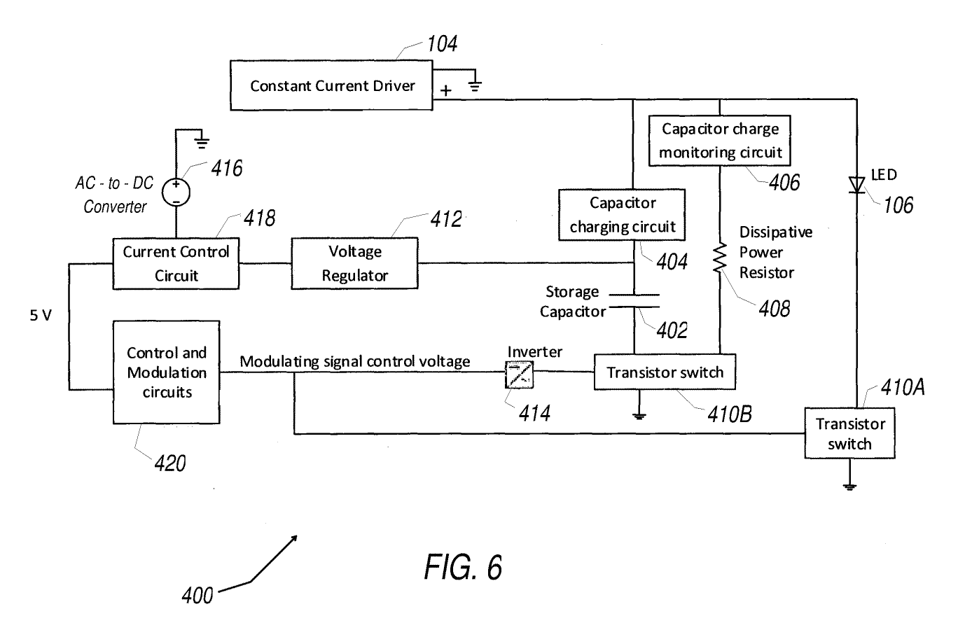

FIG. 6 is a simplified embodiment of a circuit 400 wherein LED off-cycle power is partly used to charge a storage capacitor 402, which in turn is used to feed power to a voltage regulating circuit to output a constant 5 volts DC. This circuit is especially useful if battery power is being used. Rather than simply dissipating power when the LED is not being illuminated, the power is stored and used to partially power the device. However, it is also useful when the device is being powered by the AC mains, as the circuit of FIG. 6 always contributes to minimizing the amount of energy that must be used.

A capacitor charging circuit 404 acts to charge storage capacitor 402 in a safe way. In one embodiment, a capacitor charge monitoring circuit 406 acts to maintain a constant flow of current out of the driver 104 as the capacitor nears full charge by, at that time, diverting the current to a dissipative power resistor 408 instead of storage capacitor 402. In one embodiment, this is accomplished by simply using a Zener diode to bleeds off the current when the voltage on the capacitor reaches the Zener voltage.

The nature of a voltage regulator 412 depends on the exact voltage level of the storage capacitor 402. Voltage regulator 412 can include a boost converter if the voltage in storage capacitor 402 is below 5 volts, a buck converter if the voltage in storage capacitor 402 is above 5 volts, or a buck-boost converter if the voltage in the storage capacitor is at times below and at times above 5 volts.

It is possible that the LED “off” cycle is too short at times resulting in insufficient power to run the circuits. For this reason an AC-to-DC transformer or converter 416 is included to supply the additional power. It is attached to a current control circuit 418 which monitors the available current coming from voltage regulator 402. If the available current coming from voltage regulator 402 is insufficient to power the control and modulation circuit 420, then current control circuit 418 sources current from the AC-to-DC converter 416, thus maintaining a reliable flow of power to the control and modulation circuit 420. Control and modulation circuit 420 provides a direct output to transistor switch 410A to control LED 106 and an output via inverter 414 to control transistor switch 410B, so that only one of transistor switch 410A and transistor switch 410B are on at any given time, in a manner analogous to that described in FIG. 4.

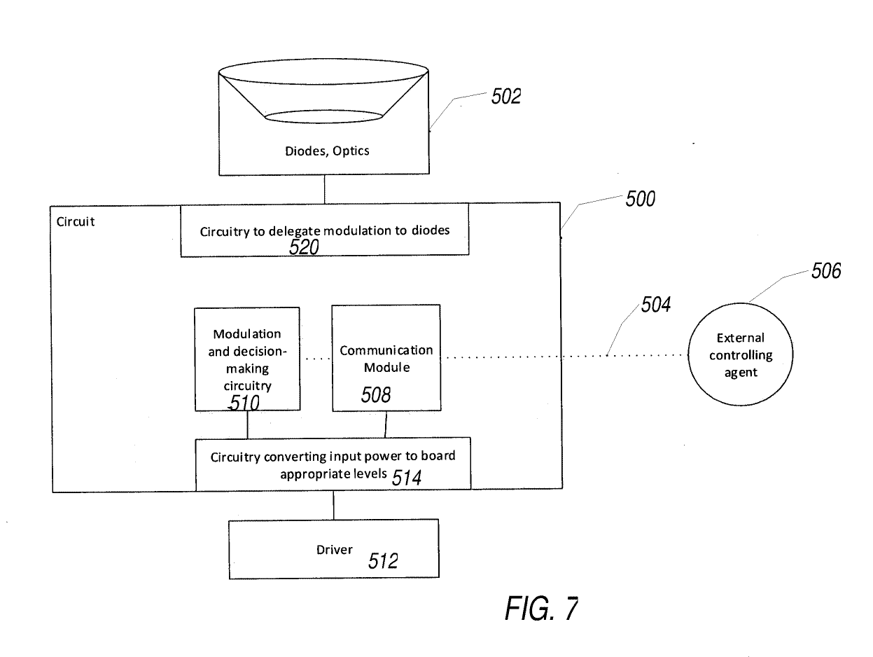

In FIG. 7, a circuit 500 as disclosed herein is depicted in its immediate environment. It is capable of receiving instructions from a controlling agent external to a luminaire 502 including LEDs and optical components, over a network 504 depicted by dashed lines, and delivering device status over the network 504. The instructions sent to the circuit 500, from an external controlling agent 506, in turn modify the behavior of the circuit 500, as software running on the circuits changes electrical outputs. In the embodiments described above, the communication module 508 is of a particular variety, and the modulation and decision making circuitry 510 is a combination of two microcontrollers. These specifics are not considered essential to the currently described embodiments, and may be replaced by components that perform equivalent tasks. FIG. 7 also includes a driver or power source 512 and circuitry 514 for converting input power to circuit board appropriate levels. Circuitry 520 to convey a modulated input to the luminaire 502 is as described above.

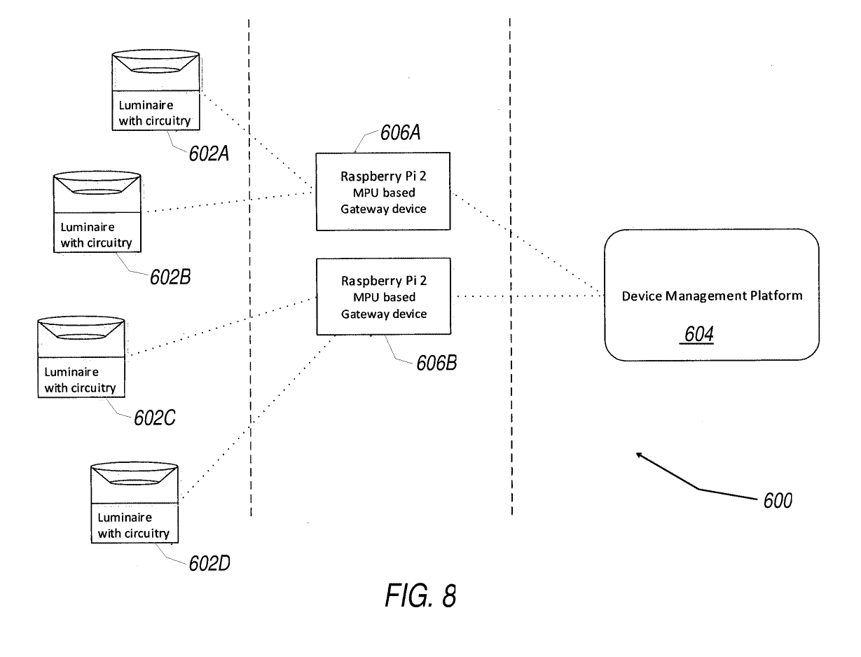

In FIG. 8, the various embodiments are placed in context of a related system 600 whereby data can be collected from and control is exerted over remotely placed devices 602A, 602B, 602C . . . 602N (each device including, for example, a luminaire, an adapter of the type described herein and a power supply or a connection thereto), from a device management platform 604. Device management platform 604, which can be cloud based, can include a sensor readings database. Only key portions of the entire network devices are depicted, not including, for instance, routers, here exemplified by internet addressable Raspberry Pi 2 devices. The platform 604 communicates with one or more gateway devices 606A, 606B, etc. using, for example, the websockets protocol. The gateway devices 606A, 606B, in turn communicate with one or more adapters of devices 602A, 602B, 602C . . . 602N using, for example, a Bluetooth mesh. Software agents developed by Basic6 (of the type described in application Ser. No. 14/671,694 filed on Mar. 27, 2015, and published as United States Patent Publication No. 2015/0281337) on the internet-addressable gateway devices 606A, 606B, are capable of maintaining full duplex websocket communication channels for real-time control of the remote devices, of routing that information to the correct end-point adapter over the Bluetooth mesh, of receiving sensor readings, making control decisions rooted in the algorithms of the resident software, of exerting the relevant controls corresponding to those decisions, and of delivering sensor readings to cloud-based services. In this manner, the network of the luminaires is not directly connected to, nor accessible from, the internet.

A user driving the device management platform 604 can view the sensor readings and the status of the luminaires and associated sensors, and can exercise control of all or a subset of the lights, acting on the subset as a whole, as well as status of and control over the gateway devices 606A, 606B. The ability to control the devices includes replacing the software on them remotely, and to deliver security tokens used for secure communications to the devices, as also described in application Ser. No. 14/671,694 filed on Mar. 27, 2015, and published as United States Patent Publication No. 2015/0281337.

The techniques described herein are exemplary, and should not be construed as implying any particular limitation on the present disclosure. It should be understood that various alternatives, combinations and modifications could be devised by those skilled in the art. For example, steps associated with the processes described herein can be performed in any order, unless otherwise specified or dictated by the steps themselves. The present disclosure is intended to embrace all such alternatives, modifications and variances that fall within the scope of the appended claims.

The terms “comprises” or “comprising” are to be interpreted as specifying the presence of the stated features, integers, steps or components, but not precluding the presence of one or more other features, integers, steps or components or groups thereof.

What is claimed is:

1. An apparatus comprising:
a light emitting diode;
a constant current source for driving the light emitting diode;
modulation circuitry to modulate the current supplied to the light emitting diode by the constant current source at a rate sufficient so that digital information is carried on light emitted by the light emitting diode, wherein the modulation circuitry includes at least one of a microcontroller and a microprocessor; and
filtering circuitry to minimize voltage and current oscillations experienced by the constant current source when modulating the current supplied to the light emitting diode, whereby the constant current source functions normally and outputs a substantially constant current, and wherein the filtering circuit contains at least one power storing element to store energy provided by the constant current source when the light emitting diode is off, and wherein the component supplies the energy to the light emitting diode when the light emitting diode is on.

2. The apparatus of claim 1, further comprising communication circuitry for allowing the at least one of the microcontroller and the microprocessor to communicate via a network.

3. The apparatus of claim 1, wherein the filtering circuit is selected from the group consisting of a pi filter, a T filter, an RC filter and an active filter.

4. The apparatus of claim 1, wherein the filtering circuit is a pi filter.

5. The apparatus of claim 1, wherein the filtering circuitry maintains the lifetime or reliability of the constant current source

6. The apparatus of claim 1, disposed in an adapter to be used to provide power from a source to a light emitting diode.

7. An apparatus comprising:
a light emitting diode;
a constant current source for driving the light emitting diode;
modulation circuitry to modulate the current supplied to the light emitting diode by the constant current source at a rate sufficient so that digital information is carried on light emitted by the light emitting diode, wherein the modulation circuitry includes:
at least one of a microcontroller and a microprocessor;
a first switching element for supplying power to the light emitting diode;
a power storing element; and
a second switching element for supplying current to the power storing element;
wherein only one of the first switching element and the second switching element supply power at a given time, so that the current supplied by the constant current source remains substantially constant.

8. The apparatus of claim 7, further comprising communication circuitry for allowing the at least one of the microcontroller and the microprocessor to communicate via a network.

9. The apparatus of claim 7, wherein the one of a microcontroller and a microprocessor acts as a modulation signal source for supplying a modulation signal to one of the first switching element and the second switching element, further comprising:
a logic inverter for supplying an inverted form of the modulation signal to another of the first switching element and the second switching element.

10. The apparatus of claim 9, wherein only one of the first switching element and the second switching element supply power at a given time.

11. The apparatus of claim 7, wherein the power storing element is a capacitor, further comprising a voltage regulator circuit for regulating the voltage produced across the capacitor.

12. The apparatus of claim 11, wherein the voltage regulator circuit includes a boost converter if the voltage in the capacitor is below a predetermined voltage.

13. The apparatus of claim 11, wherein the voltage regulator circuit includes a buck converter if the voltage in the capacitor is above a predetermined voltage.

14. The apparatus of claim 11, wherein the voltage regulator circuit includes a buck-boost converter if the voltage in the capacitor is at times below and at times above a predetermined voltage.

15. The apparatus of claim 7, disposed in an adapter to be used to provide power from a source to a light emitting.

16. The apparatus of claim 7, packaged as a self-contained unit for connection to a power source.

17. The apparatus of claim 7, wherein power stored in the power storing element is used to power related circuitry performing tasks other than control and signal modulation

18. A method for powering a light emitting diode, comprising:
using a constant current source to power the light emitting diode; and
modulating current supplied by the constant current source at a frequency for transmitting digital data on light produced by the light emitting diode; and
using a filter circuit between the constant current source and the light emitting diode to so that voltage and current oscillations experienced by the constant current source when modulating the current supplied to the light emitting diode are reduced, whereby the constant current source functions normally and outputs a substantially constant current.

19. A method for powering a light emitting diode, comprising:
using a constant current source to power the light emitting diode;
modulating current supplied by the constant current source at a frequency for transmitting digital data on light produced by the light emitting diode; and
diverting current from the constant current source away from the light emitting diode, when the light emitting diode is modulated to not emit light; wherein the current is diverted to one of an energy dissipating and an energy storage device.
